(19) United States
(12) Patent Application Publication
(10) Pub. No.: US 2009/0291292 A1
(43) Pub. Date: Nov. 26, 2009

(54) OPTICALLY ACTIVE ELEMENTS INCLUDING MULTIPLE BEAD LAYERS

(75) Inventors: Terrance L. Bescup, Hudson, WI (US); Eugene H. Carlson, Apple Valley, MN (US); Matthew D. Wilding, White Bear Lake, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/125,749

(22) Filed: May 22, 2008

(51) Int. Cl. B32B 5/16; B27N 3/00

(52) U.S. Cl. 428/323; 156/62.2

(57) ABSTRACT

The present application relates to optically active elements and the methods of making these elements. The optically active elements include multiple layers of optically active beads positioned adjacent to a core particle. The methods of making these optically active elements involve applying multiple layers of optically active beads around a core particle. At least some of the optically active elements exhibit increased durability and/or performance due to the inclusion of multiple layers of optically active beads.

### TECHNICAL FIELD

The present application relates generally to methods of coating a core element with multiple layers of optically active elements and the optically active articles formed thereby.

### BACKGROUND

The use of pavement markings (e.g., paints, tapes, and individually mounted articles) to guide and direct motorists traveling along a roadway is well known. During the daytime, the markings may be sufficiently visible under ambient light to effectively signal and guide a motorist. At night, however, especially when the primary source of illumination is the motorist's vehicle headlights, the markings are generally insufficient to adequately guide a motorist because the light from the headlight hits the pavement and marking at a very low angle of incidence and is largely reflected away from the motorist. Further, during rainfall, a thin film of water is coated over the horizontal surfaces of a roadway, and this film of water causes beams from the headlights of an automobile, or other vehicle, to be reflected off of the roadway marking at distances over about 100 feet ahead of the automobile. Over approximately 82% of the light from automobile headlights is reflected such that the light is lost to the driver of the automobile. Consequently, the roadway appears to be “pitch-black,” making safe driving challenging. For these reasons, improved pavement markings with retroreflective properties are desirable.

Retroreflection describes the mechanism where light incident on a surface is reflected so that much of the incident beam is directed back towards its source. The most common retroreflective pavement markings, such as, for example, lane lines on roadways, are typically made by dropping transparent glass or ceramic microspheres or beads onto a freshly painted line such that the microspheres or beads become partially embedded therein. The transparent microspheres each act as a spherical lens and thus, the incident light passes through the microspheres to the base paint or sheet striking pigment particles therein. The pigment particles scatter the light redirecting a portion of the light back into the microsphere such that a portion is then redirected back towards the light source.

U.S. Pat. Nos. 3,043,196 and 3,175,935, assigned to the assignee of the present application, describes reflective elements for flat, horizontal surfaces such as, for example, aircraft runways, highways, traffic lanes, and roadway dividers. These patents describe reflective elements including a single layer of optically active beads bonded, attached, or affixed to a core particle by means of a binder layer.

In addition to providing the desired retroreflective properties, pavement markings are often required to withstand road traffic and weathering over an extended duration of time.

### SUMMARY

There is a continuing need to improve the performance, reduce the cost, and to simplify the manufacture of optically active pavement markings.

The present application relates to an optically active element, comprising: a core particle; a first layer that is adjacent to the core particle and that includes a first binder and a first set of optically active beads affixed to the first binder; and a second layer that is adjacent to the first layer and that includes a second binder and a second set of optically active beads affixed to the second binder.

The present application also relates to an optically active element, comprising: a core particle; a first binder adjacent to at least a portion of the core particle; a first set of optically active beads affixed to the first binder; a second binder adjacent to the first set of optically active beads; and a second layer of optically active beads affixed to the second binder.

The present application also relates to a method of forming an optically active element, comprising: applying a first binder onto at least a portion of a core particle; placing optically active beads onto at least a portion of the first binder; applying a second binder onto at least a portion of the optically active beads; and placing optically active beads onto at least a portion of the second binder.

The present application also relates to a method of forming an optically active element, comprising: obtaining a core particle; forming a first layer that is adjacent to the core particle and that includes a first binder and optically active beads affixed to the first binder; and forming a second layer that is adjacent to the first layer and that includes a second binder and optically active beads affixed to the second binder.

The present application also relates to a durable, optically active paint composition comprising: paint; and multiple optically active elements of the types described above.

### BRIEF DESCRIPTION OF DRAWINGS

FIG. 1 is a cross-sectional view of an exemplary embodiment of a reflective element of the present application.

FIGS. 2 and 3 are charts showing the increased brightness retention of the reflective element of FIG. 1.

### DETAILED DESCRIPTION

Prior art optically active elements have some disadvantages. In instances where the beads are used in paint or other roadways markings, the beads are exposed to significant wear and tear in the form of, for example, vehicles driving over the optically active elements, optically active element exposure to potentially extreme weather, and optically active element exposure to the natural contraction of expansion of concrete roadways. All of these factors, and others, can cause the beads that are bonded, attached, or affixed to the core particle to become dislodged from the core particle. Because the beads are typically the optically active portion of the optically active element, this dislodging can cause the entire optically active element to exhibit decreased optical performance.

The present application describes improved optically active elements that minimize at least some of these disadvantages and describes methods of making the improved optically active elements.

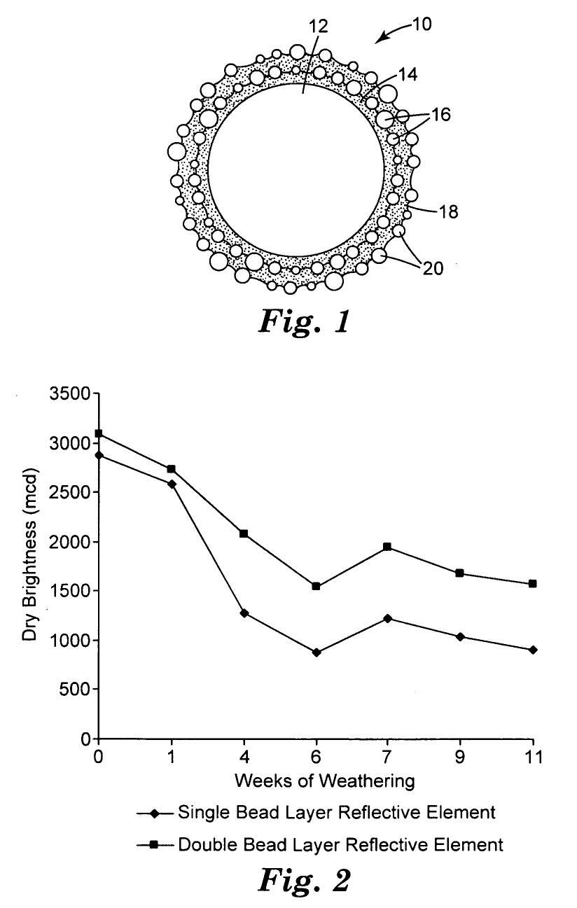

FIG. 1 is a cross-section of one exemplary embodiment of an improved optically active element 10. As is shown in FIG. 1, an improved optically active element 10 includes a core particle 12 coated with (1) a first binder 14 to which is attached multiple optically active beads 16 and (2) a second binder 18 to which is attached multiple optically active beads 20. For convenience, first binder 14 and the optically active beads 16 attached thereto can be referred to as a first layer, and second binder 18 and the optically active beads 20 attached thereto can be referred to as a second layer. The first and second layers may be of uniform thickness or may vary in thickness.

The core particle can be any type and size core particle known to those of ordinary skill in the art. One exemplary preferred core particle is sand. The desired size of the core particle may vary depending on the desired end use of the reflective element.

The first and second binder layers may include any binder or adhesive known to those of ordinary skill in the art and having properties that allow the binder or adhesive to anchor, bond, affix, or adhere the optically active beads to the core particle. Classes of binders suitable for use in the optically active elements described herein generally include epoxies, polyurethanes, alkyds, acrylics, polyesters, phenolics, and the like. One exemplary preferred binder or adhesive is a diffuse or specular pigmented liquid binder such as, for example, a pearl pigmented polyurethane binder.

Exemplary commercially available binders include certain epoxy resins such as those available from 3M Company, St. Paul, Minn. under the trade designation “3M Scotchcast™ Electrical Resin Product No. 5” and certain polyurethanes including those derived from the reaction product of a trifunctional polyol, such as those commercially available from Dow Chemical, Danbury, Conn. under the trade designation “Tone 0301,” with an adduct of hexamethylene diisocyanate (HDI), such as commercially available from Bayer Corp., Pittsburgh, Pa. under the trade designation “Desmodur N-100” at a weight ratio of about 1:2. Other polyester polyols that may be employed at appropriate equivalent weights include “Tone 0305,” “Tone 0310,” and “Tone 0210.” Further, other polyisocyanates include “Desmodur N-3200,” “Desmodur N-3300,” “Desmodur N-3400,” “Desmodur N-3600,” as well as “Desmodur BL 3175A.” The binder layer(s) may optionally comprise other ingredients such as fillers (e.g., glass beads) and solvents.

The first and second binders (or the binders used in the first and second layers) may be the same or may be different. Additionally, multiple binders or adhesives can be used to obtain the desired adhesion and cushioning properties for each layer and to improve or increase the durability and brightness retention of the reflective elements. The binder or adhesive may also provide some degree of dirt resistance and/or may improve bond strength of the optically active element to a substrate (e.g., paint, epoxy, thermoplastic, etc).

The optically active beads (also referred to as microcrystalline microspheres) can be any type, diameter, and refractive index known to those of ordinary skill in the art. Some exemplary optically active beads have a crystalline phase or a combination of an amorphous phase and a crystalline phase. The optically active beads may be non-vitreous, such as, for example, those described in U.S. Pat. No. 4,564,556 (Lange), or may comprise a glass-ceramic material, such as, for example, those described in U.S. Pat. No. 6,461,988 (Budd, et al.). The optically active beads are preferably ceramic (e.g., glass-ceramic). As used herein, “ceramic” refers to an inorganic material that is predominantly crystalline and typically having a microcrystalline structure (a material having a patterned atomic structure sufficient to produce a characteristic x-ray diffraction pattern). Exemplary ceramic beads include, but are not limited to, zirconia, alumina, silica, titania, and mixtures thereof. These beads have at least one crystalline phase containing at least one metal oxide. The beads may also have an amorphous phase, such as, for example, silica. At least some preferred beads are resistant to scratching and chipping, are relatively hard (above 700 Knoop hardness), and are made to have a relatively high index of refraction.

The optically active beads affixed by the first binder may be the same as or different than the optically active beads affixed by the second binder. The type, diameter, and refractive index of the optically active beads may be chosen based on the desired application and performance of the reflective element. That said, in one preferred exemplary implementation, core particle dimensions have a diameter ranging from about 0.2 to about 10 millimeters and the optically active beads range in size from about 30 to about 300 micrometers in diameter.

The optically active beads may be colored to retroreflect a variety of colors. Further, the beads may be color matched to the substrate to which they are adjacent, such as for example, color matching of beads to marking paints in which they are embedded. Techniques to prepare colored ceramic beads that can be used herein are described in U.S. Pat. No. 4,564,556 (Lange).

One exemplary embodiment of a method of forming an optically active element of the present application involves applying a first binder to a core particle. Optically active beads are then applied to the first binder such that the optically active beads stick or are bonded, adhered, or affixed to or into the first binder. These steps form a “single” bead layer optically active element. “Single” bead layer refers only to an optically active element having a first bead layer; this first bead layer may include, for example, multiple binders or binder layers and may include multiple beads stacked atop one another. The optically active element may be cured at this stage or at a later stage. A second binder is then applied to the single bead layer optically active element. Optically active beads are then applied to the second binder such that the optically active beads stick or are bonded, adhered, or affixed to or into the second binder. These steps form a double bead layer reflective element. “Double” bead layer refers only to an optically active element having a first bead layer of any type and a second bead layer of any type; this second bead layer may include, for example, multiple binders or binder layers and may include multiple beads stacked atop one another. The reflective element may be cured at this stage or at a later stage. One of skill in the art will recognize that additional bead and/or binder layers may be formed.

In some exemplary embodiments, the optically active elements may be incorporated, attached, or placed into or adjacent to a substrate. In cases where the optically active elements are used in a traffic marking paint system, the substrate may be, for example, paint or epoxy. In cases where the optically active elements are used in thermoplastic traffic marking systems, the substrate may be, for example, a thermoplastic. The optically active elements may be used or incorporated into other substrates and/or fields of use.

The size of the beads used in each of the first and second (and any additional layers) may be the same or may be different. In some exemplary embodiments, increased or improved bead adhesion can be achieved by matching or tailoring the diameter of the beads used in each bead layer to yield improved bead packing. For example, bead packing can be improved by using narrow bead diameter distributions within each bead layer. In many instances, a narrow bead diameter distribution includes beads whose diameters vary by less than 25%, more preferably 15%, more preferably 10%, and most preferably 5%. In some alternative embodiments, the bead diameter either within a single layer or of the beads included in a single optically active element may differ.

In some exemplary embodiments, non-spherical particles, such as, for example, glass cullet, finer sand, ground plastics, and vinyls can be incorporated into one or more bead layers or can be used as their own layer to provide, for example, increased or improved anchoring. Additionally, softer particles may be incorporated into the layers or as their own layer to, for example, impart a cushioning effect. The anchoring and optical layers may work together to improve durability and performance. Additionally, the optically active element may include at least one light scattering material including diffusely reflecting pigments, specularly reflecting pigment, and/or a combination thereof. Also, other pigments may be added to the core material to produce a colored reflective element.

The optically active elements may be, for example, reflective or retroreflective. The reflective elements may comprise a combination of microcrystalline microspheres or optically active beads having different refractive indexes. The optically active elements preferably range in size from about 2 mm to about 3 mm. The elements may include a single inorganic particle within the bonded resin core such as, for example, sand, roofing granules, or skid particles. The optically active beads and/or the optically active elements may be surface treated with an adhesion-promoting agent such as, for example, organosilane, or may be surface treated with at least one fluorochemical floatation agent.

The optically active element may include optically active beads having the same, or approximately the same refractive index. Alternatively, the reflective element may comprise beads having two or more refractive indices. Likewise, the pavement marking substrate or material may include optically active elements having the same refractive index or optically active elements having two or more refractive indices. Further yet, the pavement marking material may include a multiple bead layer element in combination with one or more single layer bead elements. Typically, beads having a higher refractive index perform better when wet and beads having a lower refractive index perform better when dry. When a blend of beads having different refractive indices is used, the ratio of the higher refractive index beads to the lower refractive index beads is preferably about 1.4 to about 1.05, and more preferably from about 1.3 to about 1.08.

Typically, for optimal reflective effect, the beads have a refractive index ranging from about 1.5 to about 2.0 for optimal dry retroreflectivity, preferably ranging from about 1.5 to about 1.9. For optimal wet retroreflectivity, the beads have a refractive index ranging from about 1.7 to about 2.8, preferably ranging from about 1.9 to 2.6, and more preferably ranging from about 2.4 to about 2.6.

The optically active elements of the present application can be used in various ways. One exemplary use for these optically active elements is in paint and/or thermoplastic pavement marking systems. Because the optically active elements include multiple layers of optically active beads, brightness retention over time is increased over prior art reflective elements. This is in part because as some of the optically active beads in the optical layer exposed to the viewer become dislodged from the optically active element, an underlying layer of optically active beads is exposed to the viewer. Thus the time span during which each optically active element maintains its optical activity is increased.

Further, the multiple layers of optically active elements may cause the multiple bead layer elements to be more durable than prior art single bead layer elements. In the embodiments in which the multiple bead layers are uniform, a closed order tetrahedral bead packing that may be obtained in some exemplary implementations may improve bead adhesion, thereby yielding a more durable optically active element and providing increased brightness retention.

Objects and advantages of the present application are further illustrated by the following examples, but the particular materials and amounts thereof recited in the examples, as well as other conditions and details, should not be construed to unduly limit the application. All parts, percentages and ratios herein are by weight unless otherwise specified.

### EXAMPLE 1

Sand particles (sold under trade name T12X201 manufactured by Badger Mining, Berlin, Wis.) having a diameter between 800 and 1400 microns were treated with 600 ppm of Silquest A 1100 silane coupling agent (manufactured by GE Silicones Friendly of Friendly, W. Va.). Pearl pigmented polyurethane (manufactured by Gibraltar of South Holland, Ill.) was coated onto the sand particles in a weight ratio of approximately 10:1 (sand to polyurethane). The polyurethane coated sand particles (50 g) were added to a 1000 ml beaker containing 500 grams of optically clear glass ceramic beads (manufactured by 3M Company of St. Paul, Minn.) having a refractive index of 1.89. Alternatively, glass beads having a refractive index of 1.9 manufactured by Swarco could be used. This created a weight ratio of approximately 10:1 (beads to coated sand particles). The sand particle-bead combination was stirred for 10 seconds with a kitchen mixer (Oster, Model 2532) on high speed causing the formation of discrete reflective elements. The resulting discrete reflective elements were separated from the excess beads using a sieve and were then cured overnight in an 80° C. oven.

A second layer of the pearl pigmented polyurethane was then coated onto the single bead layer dry reflective elements in a weight ratio of approximately 7:1 (reflective element to polyurethane). The polyurethane coated reflective elements (50 grams) were added to a 1000 ml beaker containing 500 grams of the optically clear glass ceramic beads having a refractive index of 1.89. This created a weight ratio of approximately 10:1 (beads to coated reflective elements). The bead-reflective element combination was stirred for 10 seconds with the kitchen mixer on high speed causing the formation of discrete, double bead layer reflective elements. The resulting discrete, double bead layer reflective elements were separated from the excess beads using a sieve and were then cured overnight in an 80° C. oven.

Prior art single bead layer dry reflective elements (including the same core particle, optical beads, and binder as the above-described double bead layer reflective elements) and the above-described double bead layer reflective elements were installed and tested for 11 weeks in a testing roadway during the late summer months in an eastbound lane on the left and right wheel tracks. The results of these tests are shown in the following tables.

TABLE I
Average Dry Brightness

| | Weeks of Testing | | | | | | |
|---|---|---|---|---|---|---|---|
| | 0 | 1 | 4 | 6 | 7 | 9 | 11 |
| Control Sample | 2878 | 2584 | 1283 | 878 | 1225 | 1042 | 908 |
| Brightness | | | | | | | |
| Measurements (mcd) | | | | | | | |
| Double Bead Layer | 3089 | 2733 | 2077 | 1540 | 1946 | 1671 | 1573 |
| Elements Brightness | | | | | | | |
| Measurements (mcd) | | | | | | | |

TABLE II
Average Dry Brightness Retention

| | Weeks of Testing | | | | | | |
|---|---|---|---|---|---|---|---|
| | 0 | 1 | 4 | 6 | 7 | 9 | 11 |
| Control Sample Brightness | 100 | 90 | 45 | 30 | 43 | 36 | 32 |
| Measurements (mcd) | | | | | | | |
| Double Bead Layer Elements | 100 | 88 | 67 | 50 | 63 | 54 | 51 |
| Brightness Measurements (mcd) | | | | | | | |

The acronym “mcd” refers to candelas/lux/m².

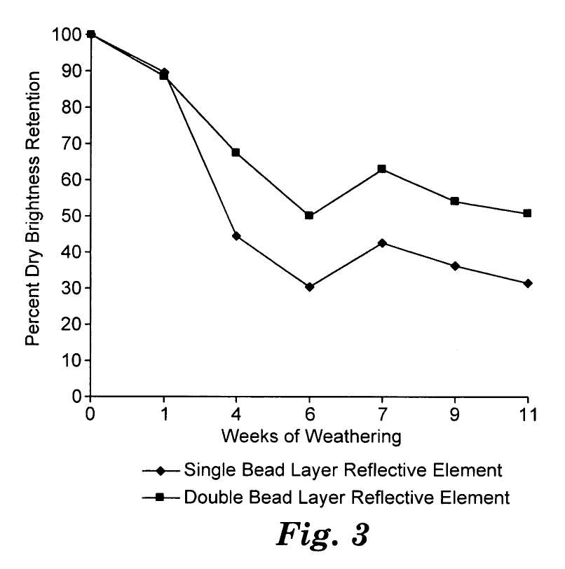

The data in Tables I and II are also shown graphically in FIGS. 2 and 3. Tables I and II and FIGS. 2 and 3 show that the double bead layer optically active elements exhibit increased brightness under dry conditions as compared to the prior art, single bead layer optically active elements.

Retroreflective optically active elements formed as described herein preferably have a coefficient of retroreflection of at least 10 candelas/lux/m² and more preferably of at least 20 candelas/lux/m². The pavement marking into which the optically active elements may be incorporated preferably exhibit an initial R_{L} according to ASTM E 1710-97 of at least 2000 millicandelas/m²/lux. Further, the pavement markings preferably exhibit an R_{L} of at least 400 millicandelas/m²/lux after 22 weeks of accelerated wear testing.

Those having skill in the art will appreciate that many changes may be made to the details of the above-described embodiments and implementations without departing from the underlying principles thereof. The scope of the present application should, therefore, be determined only by the following claims.

What is claimed is:

1. An optically active element, comprising:
a core particle;
a first layer that is adjacent to the core particle and that includes a first binder and a first set of optically active beads affixed to the first binder; and
a second layer that is adjacent to the first layer and that includes a second binder and a second set of optically active beads affixed to the second binder.

2. The optically active element of claim 1, wherein the first and second layers are of uniform thickness.

3. The optically active element of claim 1, wherein the first and second layers vary in thickness.

4. The optically active element of claim 1, wherein the first and second binders have the same composition.

5. The optically active element of claim 1, wherein the first and second binders vary in composition.

6. The optically active element of claim 1, wherein the optically active beads in one of the first layer or the second layer have at least one of different refractive indices, different diameters, or different compositions.

7. The optically active element of claim 1, wherein the optically active beads in one of the first layer or the second layer have at least one of the same refractive indices, the same diameters, or the same compositions.

8. The optically active element of claim 1, wherein the optically active beads in the first and second sets have at least one of different refractive indices, different diameters, or different composition.

9. The optically active element of claim 1, wherein the optically active beads in the first and second sets have at least one of the same refractive indices, the same diameters, or the same composition.

10. The optically active element of claim 1, wherein each optically active bead has a bead diameter and the distribution of bead diameters within at least one of the first or second layers is narrow.

11. The optically active element of claim 1, wherein the core particle is sand.

12. The optically active element of claim 1, wherein at least one of the first or second binders is a diffuse or specular pigmented liquid binder.

13. The optically active element of claim 1, wherein at least one of the first or second binders includes multiple binders or adhesives.

14. The optically active element of claim 1, further comprising:
a substrate to which the reflective element is adjacent.

15. The optically active element of claim 14, wherein the substrate is one of a paint, an epoxy, or a thermoplastic.

16. The optically active element of claim 1, wherein at least portions of the first and second layers are not directly adjacent.

17. The optically active element of claim 1, wherein the optically active beads are reflective or retroreflective.

18. A method of forming an optically active element, comprising:
applying a first binder onto at least a portion of a core particle;
placing optically active beads onto at least a portion of the first binder;
applying a second binder onto at least a portion of the optically active beads; and
placing optically active beads onto at least a portion of the second binder.

19. The method of claim 18, further comprising:
curing at least one of the first and second binder.

20. The method of claim 23, further comprising repeating the steps of applying a second binder onto at least a portion of the optically active beads; and placing optically active beads onto at least a portion of the second binder multiple times.

21. A method of forming an optically active element, comprising:
obtaining a core particle;
forming a first layer that is adjacent to the core particle and that includes a first binder and optically active beads affixed to the first binder; and
forming a second layer that is adjacent to the first layer and that includes a second binder and optically active beads affixed to the second binder.

22. A durable, optically active paint composition comprising:
paint; and
multiple optically active elements of claim 1.
